(19) United States
(12) Patent Application Publication
(10) Pub. No.: US 2010/0186784 A1
(43) Pub. Date: Jul. 29, 2010

(54) DEVICE FOR CLEANING OF ENCLOSED SPACES

(76) Inventors: Martin Ross, Sjobo (SE); Thomas Jinbäck, Eslov (SE); Magnus Wallin, Fjaras (SE); Joacim Cronholm, Barseback (SE)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/600,924

(22) PCT Filed: May 27, 2008
(86) PCT No.: PCT/SE2008/050622

§ 371 Date: Mar. 19, 2010

(30) Foreign Application Priority Data
May 29, 2007 (SE) 0701299-0

(51) Int. Cl. B08B 9/093

(52) U.S. Cl. 134/167 R

(57) ABSTRACT

The invention relates to a device for cleaning of enclosed spaces (1) by means of a sprayed liquid. The device comprises an outer unit (2) situated outside the enclosed space (1) and an inner unit (3) situated within the enclosed space (1). The outer unit (2) comprises a drive device (4). Said inner unit (3) comprises at least one flushing pipe (5a) and at least one spray head (6), to which spray head (6) at least one spray nozzle (7a-b) is fitted. The spray head (6) is connected rotatably to the flushing pipe (5a). The flushing pipe (5a) comprises at least one rotatable element (8a) which communicates with, and is caused to rotate by, said drive device (4) and therefore causes the spray head (6) with spray nozzle (7a-b) to rotate so that liquid sprayed out from at least one nozzle (7a-b) during rotation sweeps over the inside of the enclosed space (1). Said liquid flows both within said flushing pipes (5a-b) and in at least two flow directions to a free end (10) of a flushing pipe (5a-b), at which free end (10) a spray head (6) is connected.

### FIELD OF THE INVENTION

The present invention relates to a device for cleaning of enclosed spaces according to the preamble of claim 1.

### BACKGROUND TO THE INVENTION

International patent specification WO-2004103586-A1 refers to a flushing device for enclosed spaces. The device according to WO-2004103586-A1 is situated on the top of an enclosed space and part of the flushing device extends down into the enclosed space via an aperture in said top. A disadvantage of a flushing device according to WO-2004103586-A1 is that a driving device and a supply of flushing liquid for the flushing device are situated on the top of the enclosed space. This means that a flushing device situated according to WO-2004103586-A1 occupies a considerable amount of space. On a containership it is desirable to have as much free space as possible on a cargo deck for the carriage of containers. The regions on cargo decks where various space-occupying connections and couplings are situated in said decks thus tend to reduce possible cargo space.

British patent specification GB-2177591-A refers to a flushing device for enclosed spaces. The flushing device according to GB-2177591-A is so configured that it can extend through a number of consecutive spaces each equipped with a flushing orifice which flushes the respective space. Each flushing orifice is connected to a straight main line which extends through the respective spaces for flushing. A shaft which acts upon the movement of each flushing orifice extends in this main line. A disadvantage of the configuration of the device according to GB-2177591-A is that the control of the orifices involves each orifice having to be connected to said straight main line. This means that in enclosed spaces not mutually in line or any space so configured as to comprise many different angles will be partly not flushed and cleaned because the jet from the flushing orifice does not reach them.

### SUMMARY OF THE INVENTION

An object of the present invention is to provide a device whereby the aforesaid problem is avoided.

A further object of the invention is to provide a device which reduces the cost of cleaning enclosed spaces which are difficult of access by making it possible to achieve more effective use of cleaning liquid in each space.

A further object of the invention is to provide a device and a method which are cost-effective compared with prior art, and which device is easy to construct, making it possible to optimize cost and time.

The aforesaid and other objects are achieved according to the invention by the device described in the introduction having the characteristics indicated in claim 1.

An advantage afforded by a device according to the characterizing part of claim 1 is that the device is self-draining, since liquid which ends up on it runs off.

A further advantage afforded by a device according to the characterizing part of claim 1 is that the device can be dismantled and easily removed from the enclosed space for cleaning, e.g. for servicing of the device.

Preferred embodiments of the device according to the invention further have the characteristics indicated by subclaims 2-12.

According to an embodiment of the invention, the inner unit comprises a second flushing pipe connected to and after said first flushing pipe, whereby said flushing pipes together form a unit. Said first and second flushing pipes are connected to one another by an angle unit whereby said first and second flushing pipes form between them an angle via which said liquid flows within and between said flushing pipes. The fact that two flushing pipes are connected to and after one another via an angle unit makes it possible to angle the device to positions and spaces which are difficult of access for their cleaning.

According to an embodiment of the invention, the spray head with spray nozzle is attached to a free end of a flushing pipe in such a way that the spray nozzle can rotate both about a central axis which extends centrally through sections of flushing pipe to which spray heads are connected and about a second central axis which crosses said first central axis in a substantially perpendicular extent. It thus becomes possible for a jet of liquid sprayed out from the spray nozzle to sweep over the whole inside of the enclosed space.

According to a further embodiment of the invention, the flushing pipe connected to a spray head has a direction such that the flushing pipe and its central axis are positioned substantially vertically so that during rotation of the spray head and spray nozzle about said central axis the liquid sprays out from at least one spray nozzle in such a way that the liquid is caused to continuously sweep round and strike the inside of the enclosed space, which liquid after each complete revolution of the spray head and the spray nozzle returns to first and second intersection points on the inside of the space, the first intersection point being situated at the meeting of the extent of said first central axis and the portion of the inside constituting the bottom, the second intersection point being situated at the meeting of the extent of said first central axis and the portion of the inside which constitutes the roof. An advantage of the intersection points being situated vertically above one another is that in a normal enclosed space the dirt accumulates on the floor of the space. It is therefore desirable that an intersection point for the liquid jet is in the region of the space which has the greatest need of cleaning. The cleaning has its greatest effect at an intersection point, since that is where the greatest accumulation of water from the spray nozzle occurs.

According to a further embodiment of the invention, a second rotatable element cooperates with the first rotatable element in two mutually connected flushing pipes in the angle unit which connects the flushing pipes, by said first rotatable element in the one flushing pipe having power transferred to the second rotatable element in the second flushing pipe via a power transfer device which is situated in the angle unit. The power transfer device may take the form of either at least one bevel gearwheel, worm gear, propeller shaft gear or a bendable element such as preferably a wire, whereby power transfer can take place between two adjacent rotatable elements. An advantage of this is that it makes it possible to site a spray head in spaces difficult of access, e.g. behind walls, since the flushing pipe can be angled and need not be straight in its extent to the spray head.

According to a further embodiment of the invention, third and fourth flushing pipes are connected to and after one another by a second angle unit, each comprise third and fourth rotatable elements, are connected via one end both of the third flushing pipe and of the third element to the first angle unit for the first and second flushing pipes, and are connected at another end of the fourth flushing pipe and the fourth element to another spray head with at least one spray nozzle. Two flushing pipes, an angle unit and a spray head together constitute what is called a unit. An advantage of this is that it makes it possible to connect said unit to another unit comprising corresponding components by connecting a free end of a flushing pipe to the angle element of the adjacent unit. This makes it possible to connect a plurality of such elements in series after one another. A further advantage is the consequent possibility of having a spray head in each space which needs cleaning, without said spaces being mutually in line. Each spray head in a space can therefore be situated where it is most beneficial, since the flushing pipes allow each unit to be angled to an optimum position for the respective spray head.

This is a desirable solution in, for example, a cargo vessel with a plurality of ballast tanks. Each spray head is situated in the respective ballast tank where optimum cleaning can be effected. This is made possible by mutually connected flushing pipes in a cargo vessel being connected in series after one another through said ballast tanks and being angled in order to be led to locations which are difficult of access. The flushing pipe in each ballast tank therefore has fitted to it a spray head whereby the washing effect is optimized in the respective space.

According to a further embodiment of the invention, the first flushing pipe is connected to a portion of the inside of the enclosed space which takes the form of a wall, and the drive device in the outer unit cooperates, via a recess in said wall, with a rotatable element which extends through the first flushing pipe. An advantage of the device being fastened to a wall portion of the space for cleaning is that such siting means that the outer unit to the device does not act upon a surface situated above the enclosed space and intended for cargo of various kinds.

According to a further embodiment of the invention, said rotatable element within each flushing pipe takes the form of a rotatable shaft extending centrally through the respective flushing pipe. The shaft and the power transfer device which extend within the flushing pipe and the angle unit are protected from external influences and are lubricated during operation by the liquid which flows through the flushing pipe and the angle unit to a spray head. This means that the inner unit is substantially self-lubricating and maintenance-free.

According to a further embodiment of the invention, the first flushing pipe extends from the wall on the inside of the enclosed space at an angle such that the direction of the pipe from the wall is downward, so that liquid which ends up on the surface of the pipe, e.g. the upper side or the surface on the inside of the pipe, is caused by gravity to run off the pipe so that said pipe is self-draining. An advantage of this is that liquid or other elements are thereby prevented from remaining on the device, so the device is thereby kept clean.

According to a further embodiment of the invention, the flushing pipe and/or angle unit and/or spray head are releasably connected to one another by connecting elements. Said connecting elements may for example take the form of bolted or threaded connections whereby the various items are connected to one another via flanges. A specialist in the field will of course appreciate that other connecting elements not mentioned here which connect two items to one another may be used.

### BRIEF DESCRIPTION OF THE DRAWINGS

A preferred embodiment of the device/method according to the invention is described below in more detail with reference to the attached schematic drawings, which only depict the parts necessary for understanding the invention.

FIG. 1 depicts an angled device for cleaning, comprising two flushing pipes with an angle unit.

FIG. 2 depicts an angled device for cleaning, comprising a flushing pipe bent to a bow.

FIG. 3 depicts a system with a plurality of cleaning devices connected in series.

### DETAILED DESCRIPTION OF VARIOUS EMBODIMENTS OF THE INVENTION

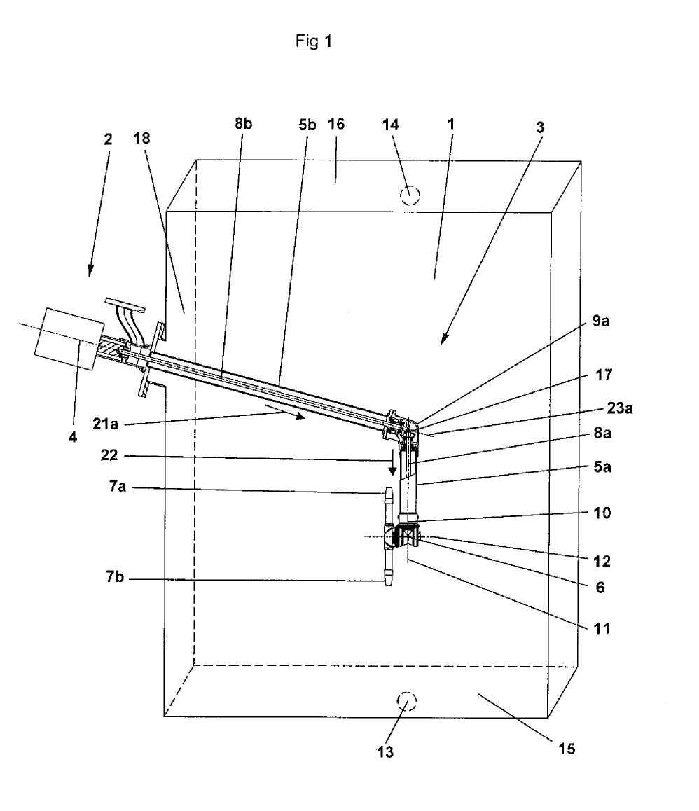

FIG. 1 depicts a device for cleaning of enclosed spaces (1). The device comprises an outer unit (2) and an inner unit (3). Said outer unit (2) comprises a drive device (4). The inner unit (3) comprises at least two flushing pipes (5a-b) connected to and after one another. The one flushing pipe (5a) is connected at a free end (10) to a spray head (6). The other free end of the flushing pipe (5b) cooperates with means which communicate with said outer unit (2). The spray head (6) comprises at least one spray nozzle (7a). Two spray nozzles (7a-b) are depicted in the embodiment according to FIG. 1.

FIGS. 1-3 show a portion of the flushing pipe (5a-b) which is adjacent to the outer unit (2) extending in at least a first pipe direction (21a, b). FIGS. 1-3 also show another portion of the flushing pipe (5a-b), preferably the free end (10) which is adjacent to the spray head (6), extending in a second pipe direction (22).

The flushing pipes (5a-b) surround a rotatable element (8a-b). Said rotatable element (8a-b) takes with advantage the form of a shaft extending centrally through said flushing pipes (5a-b). Ends between two adjacent rotatable elements (8a-b) meet in an angle unit (9) between the flushing pipes (5a-b). A first rotatable element (8a) in a first flushing pipe (5a) has power transfer to a second rotatable element (8b) in a second flushing pipe (5b) via a power transfer device (17). This power transfer device (17) according to FIG. 1 takes the form of two bevel gearwheels which cooperate with one another whereby the one gearwheel has power transfer with the second gearwheel with which it cooperates. The first gearwheel is connected to an end of said first rotatable element (8a). The second gearwheel is connected to an end of said second rotatable element (8b). The respective said ends point towards one another. Each gearwheel comprises an angled toothed rim. Power transfer between the rotatable elements (8a-b) and the gearwheels can be effected by said toothed rims being brought into contact with one another.

According to FIG. 1, the spray head (6) has its free end (10) connected rotatably to the first flushing pipe (5a). A bearing is situated at the transition between said free end (10) and the spray head (6). The bearing is situated vertically relative to a first central axis (11). The central axis (11) extends longitudinally with the extent of part of the extent of the second rotatable element (8a) and centrally through the bearing. The spray head (6) is connected to said flushing pipe (5a) and rotatable element (8b) in such a way that it can be caused to rotate about the first central axis (11).

The spray head (6) comprises said spray nozzles (7a-b). The spray nozzles (7a-b) are caused to rotate about a second central axis (12) extending through the spray head (6). This second central axis (12) extends through the first central axis (11). Said first and second central axes (11, 12) form substantially a right angle between them. This makes it possible for the spray nozzles (7a-b) to be both caused to rotate about the first central axis (11) and be caused to rotate about the second central axis (12). This makes it possible for liquid sprayed out from the spray nozzles (7a-b) to sweep over the whole inside of a space in which a spray head (6) is situated. Liquid is supplied to the device and led to said spray nozzles by methods known to one skilled in the art.

At least one third central axis (23a,b) is depicted in FIGS. 1-3. The extent of the third central axis (23a,b) extends from the outer unit (2) to the extent of the first central axis (11). The third central axis (23a,b) and the first central axis (11) meet at an angle.

The spray head (6) is connected to the flushing pipe (5a) in such a way that the flushing pipe (5a) is situated vertically above the spray head (6). This positioning of the spray head (6) results in a first intersection point (13) and a second intersection point (14) on the inside of the enclosed space (1). Said first intersection point (13) is at the meeting between the extent of the first central axis (11) and the bottom (15). Said second intersection point (14) is at the meeting between the extent of the first central axis (11) and the roof (16). At these intersection points (13, 14) a concentration of liquid from the spray nozzles (7a-b) occurs when the liquid sweeps round in the space. The intersection points (13, 14) are obtained by the spray nozzles (7a-b) being rotated both about said second central axis (12) and about said first central axis (11), resulting in a concentration of liquid at said intersection points (13, 14). The intersection points (13, 14) are defined by the liquid concentrating on collision surfaces on the floor and roof, which collision surfaces each take the form of a small circle. This is because the spray nozzles (7a-b) are at a vertical distance from the first central axis (11) which corresponds to half the width of the flushing pipe (5a), about which first central axis (11) said spray nozzles (7a-b) rotate, said intersection points (13, 14) thus taking the form of a small circular surface in the bottom (15) and roof (16) respectively.

In an enclosed space (1) the main accumulation of dust and particles occurs in the bottom of the space. The device according to the invention is therefore configured with the vertical flushing pipe (5a) with the spray head (6) connected to its free end so that the concentration of cleaning liquid should be at the bottom of the space (1).

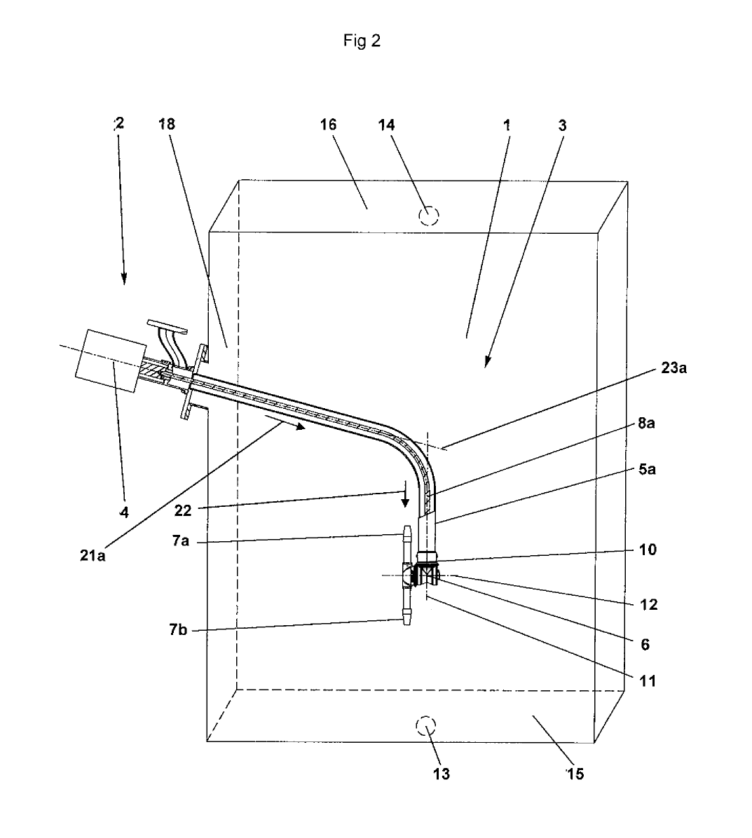

FIG. 2 depicts an embodiment of the device in which the flushing pipe (5a) takes the form of a bent pipe. The device according to FIG. 2 differs from the device according to FIG. 1 in that the angle unit is eliminated. The rotatable element (8a) according to FIG. 2 is made of flexible material which allows it to follow the shape of the flushing pipe (5a).

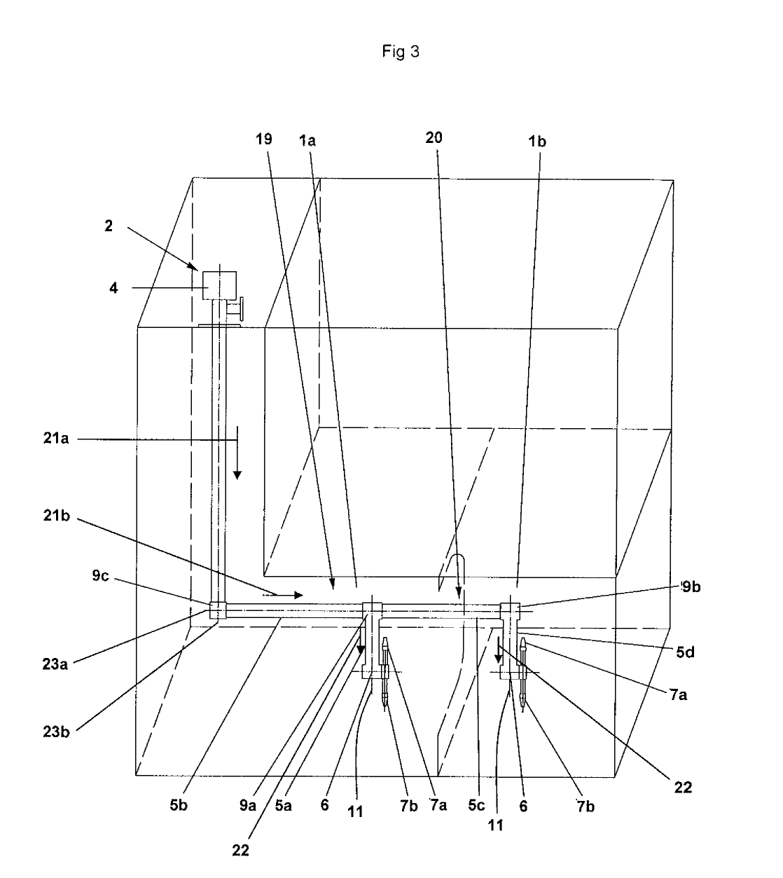

FIG. 3 depicts an embodiment of the device situated in a system comprising a plurality of series-connected devices for cleaning. In FIG. 3 a second unit (20) is connected to a first unit (19). Said first unit (19) is situated in a first space (1a). Said second unit (20) is situated in a second space (1b). Said second unit (20) communicates with the first unit (19) via a third flushing pipe (5c). The third flushing pipe (5c) is connected to the angle unit (9a) for the first unit (19). A third rotatable element (8c, not depicted) extends within said third flushing pipe (5c). The third element (8c) communicates with a power transfer device situated within the angle unit (9a) for the first unit (19). The third element (8c) is caused to rotate by said power transfer device so that the third element (8c) causes a fourth element (8d) (not depicted) to rotate. Said fourth element (8d) acts upon a spray head (6) situated in the second unit (20) so that the spray head with associated spray nozzles (7a-b) is caused to rotate. Liquid for cleaning the second space (1b) is led via the angle unit pertaining to the first unit (19) through the third flushing pipe (5c), through an angle unit pertaining to the second unit (20), through a fourth flushing pipe (5d) which surrounds said fourth element (8d), to the spray head (6) and out through the spray nozzles (7a-b) of the second unit (20) during rotation of said spray head (6) and spray nozzles (7a-b).

The invention is not limited to the embodiments described but may be varied and modified within the scope of the claims set out below.

1. A device for cleaning of enclosed spaces (1) by means of a sprayed liquid, which device comprises an outer unit (2) situated outside the enclosed space (1) and an inner unit (3) situated within the enclosed space (1), the outer unit (2) comprising a drive device (4) and the inner unit (3) comprising at least one flushing pipe (5a) and at least one spray head (6) which has at least one spray nozzle (7a-b) fitted to it and is itself connected rotatably to the flushing pipe (5a), which flushing pipe (5a) comprises at least one rotatable element (8a) which communicates with, and is caused to rotate by, said drive device (4) and therefore causes the spray head (6) with spray nozzles (7a-b) to rotate so that liquid sprayed out from at least one nozzle (7a-b) during rotation sweeps over the inside of the enclosed space (1), wherein:
a portion of the flushing pipes (5a-b) which is adjacent to the outer unit (2) has a first pipe direction (21a, b), that another portion of the flushing pipes (5a-b) which is adjacent to the spray head (6) has a second pipe direction (22), and
said liquid is adapted to flowing within said flushing pipes (5a-b) towards the spray head (6).

2. A device according to claim 1, wherein the inner unit (3) comprises a second flushing pipe (5b) connected to and after said first flushing pipe (5a), said flushing pipes (5a-b) together constituting a unit.

3. A device according to claim 1, wherein said first and second flushing pipes (5a-b) are connected to one another by an angle unit (9a) so that said first and second flushing pipes (5a-b) form between them an angle, said liquid flowing within and between said flushing pipes (5a-b).

4. A device according to claim 1, wherein the spray head (6) with spray nozzle (7a-b) is attached to a free end (10) of a flushing pipe (5a-b) in such a way that the spray nozzle (7a-b) can rotate both about a central axis (11) extending centrally through the portion of the flushing pipes (5a-b) to which the spray head (6) is connected and about a second central axis (12) which crosses said first central axis (11) in a substantially perpendicular extent.

5. A device according to claim 4, wherein the flushing pipe (5a-b) connected to a spray head (6) has a direction such that the flushing pipe (5a-b) and its central axis (11) are positioned substantially vertically so that during rotation of the spray head (6) and spray nozzles (7a-b) about said central axes (11, 12) the liquid sprays out from at least one spray nozzle (7a-b) in such a way that the liquid is continuously caused to sweep round and strike the inside of the enclosed space (1), whereby after each complete revolution of the spray head (6) and the spray nozzle (7a-b) the liquid returns to first and second intersection points (13, 14) on the inside of the space (1), said first intersection point (13) being situated at the meeting of the extent of said first central axis (11) and the portion of the inside which is constituted by the bottom (15), and said second intersection point (14) being situated at the meeting of the extent of said first central axis (11) and the portion of the inside which is constituted by the roof (16).

6. A device according to claim 3, wherein the second rotatable element (8b) cooperates with the first rotatable element (8a) in two mutually connected flushing pipes (5a-b) in the angle unit (9a) which connects the flushing pipes (5a-b), by said first rotatable element (8a) in the one flushing pipe (5a) having power transfer to the second rotatable element (8b) in the other flushing pipe (5b) via a power transfer device (17) which is situated in the angle unit (9a).

7. A device according to claim 6, wherein the power transfer device (17) may take the form either of at least one bevel gearwheel, worm gear, universal shaft gear or bendable element such as preferably a wire, whereby power transfer can take place between two adjacent rotatable elements (8a-b).

8. A device according to claim 3, wherein third and fourth flushing pipes (5c-d) are connected to and after one another via a second angle unit (9b), each comprise third and fourth rotatable elements (8c-d), are connected via an end both for the third flushing pipe (5c) and for the third element (8c) to the first angle unit (9) for the first and second flushing pipes (5a-b), and are connected at another end of the fourth flushing pipe (5d) and the fourth element (8d) to another spray head (6b) with at least one spray nozzle (7c-d).

9. A device according to claim 1, wherein the first flushing pipe (5a) is connected to a portion of the inside of the enclosed space (1) which takes the form of a wall (18), and the drive device (4) in the outer unit (2) cooperates, via a recess in said wall (18), with a rotatable element (8a) which extends through the first flushing pipe (5a).

10. A device according to claim 1, wherein said rotatable element (8a-b) within each flushing pipe (5a-d) takes the form of a rotatable shaft extending centrally through the respective flushing pipe (5a-d).

11. A device according to claim 9, wherein the first flushing pipe (5a) extends from the wall (18) on the inside of the enclosed space (1) at an angle such that the direction of the pipe (5a) from the wall (18) is downward so that liquid which ends up on the surface of the pipe (5a), e g the upper side or surface on the inside of the pipe, is caused by gravity to run off the pipe (5a), whereby said pipes (5a-d) are self-draining.

12. A device according to claim 3, wherein the flushing pipes (5a-d) and/or the angle unit (9) and/or the spray head (6) are releasably connected to one another by connecting elements.
